(19) United States
(12) Patent Application Publication
(10) Pub. No.: US 2019/0159174 A1
(43) Pub. Date: May 23, 2019

(54) METHOD FOR SETTING RESOURCE FOR DEVICE-TO-DEVICE COMMUNICATION IN WIRELESS COMMUNICATION SYSTEM, AND APPARATUS FOR SAME

(71) Applicant: LG Electronics Inc., Seoul (KR)

(72) Inventor: Hanbyul SEO, Seoul (KR)

(21) Appl. No.: 16/091,378

(22) PCT Filed: Apr. 7, 2017
(86) PCT No.: PCT/KR2017/003817

§ 371 Date: Oct. 4, 2018

Related U.S. Application Data
(60) Provisional application No. 62/324,877, filed on Apr. 19, 2016.
(60) Provisional application No. 62/320,431, filed on Apr. 8, 2016.

(51) Int. Cl. H04W 72/02; H04W 76/14

(52) U.S. Cl. CPC H04W 72/02; H04W 84/18; H04W 76/14

(57) ABSTRACT

Disclosed in the present application is a method by which a terminal sets a resource for sidelink transmission in a wireless communication system. More specifically, the method comprises the steps of: selecting, from within a preset resource pool, the resource for sidelink transmission; determining whether to reselect the resource for the subsequent sidelink transmission on the basis of a predetermined probability; performing sidelink transmission by using the selected resource; and performing the subsequent sidelink transmission on the basis of whether the resource is reselected, wherein the step of performing sidelink transmission comprises the step of transmitting information related to whether the resource us reselected for the subsequent sidelink transmission.

### TECHNICAL FIELD

The present invention relates to a wireless communication system, and more particularly, to a method of configuring a resource for Device-to-Device (D2D) direct communication in a wireless communication system and apparatus therefor.

### BACKGROUND ART

3GPP LTE (3rd generation partnership project long term evolution hereinafter abbreviated LTE) communication system is schematically explained as an example of a wireless communication system to which the present invention is applicable.

FIG. 1 is a schematic diagram of E-UMTS network structure as one example of a wireless communication system. E-UMTS (evolved universal mobile telecommunications system) is a system evolved from a conventional UMTS (universal mobile telecommunications system). Currently, basic standardization works for the E-UMTS are in progress by 3GPP. E-UMTS is called LTE system in general. Detailed contents for the technical specifications of UMTS and E-UMTS refers to release 7 and release 8 of “3rd generation partnership project; technical specification group radio access network”, respectively.

Referring to FIG. 1, E-UMTS includes a user equipment (UE), an eNode B (eNB), and an access gateway (hereinafter abbreviated AG) connected to an external network in a manner of being situated at the end of a network (E-UTRAN). The eNode B may be able to simultaneously transmit multi data streams for a broadcast service, a multicast service and/or a unicast service.

One eNode B contains at least one cell. The cell provides a downlink transmission service or an uplink transmission service to a plurality of user equipments by being set to one of 1.25 MHz, 2.5 MHz, 5 MHz, 10 MHz, 15 MHz, and 20 MHz of bandwidths. Different cells can be configured to provide corresponding bandwidths, respectively. An eNode B controls data transmissions/receptions to/from a plurality of the user equipments. For a downlink (hereinafter abbreviated DL) data, the eNode B informs a corresponding user equipment of time/frequency region on which data is transmitted, coding, data size, HARQ (hybrid automatic repeat and request) related information and the like by transmitting DL scheduling information. And, for an uplink (hereinafter abbreviated UL) data, the eNode B informs a corresponding user equipment of time/frequency region usable by the corresponding user equipment, coding, data size, HARQ-related information and the like by transmitting UL scheduling information to the corresponding user equipment. Interfaces for user-traffic transmission or control traffic transmission may be used between eNode Bs. A core network (CN) consists of an AG (access gateway) and a network node for user registration of a user equipment and the like. The AG manages a mobility of the user equipment by a unit of TA (tracking area) consisting of a plurality of cells.

Wireless communication technologies have been developed up to LTE based on WCDMA. Yet, the ongoing demands and expectations of users and service providers are consistently increasing. Moreover, since different kinds of radio access technologies are continuously developed, a new technological evolution is required to have a future competitiveness. Cost reduction per bit, service availability increase, flexible frequency band use, simple structure/open interface and reasonable power consumption of user equipment and the like are required for the future competitiveness.

### DISCLOSURE OF THE INVENTION

### Technical Task

Based on the aforementioned discussion, the technical task of the present invention is to propose a method of configuring a resource for Device-to-Device (D2D) direct communication in a wireless communication system and apparatus therefor.

### Technical Solutions

In one technical aspect of the present invention, provided herein is a method of configuring a resource for sidelink transmission by a user equipment in a wireless communication system, the method including selecting the resource for the sidelink transmission from a preset resource pool, determining whether to reselect the resource in a subsequent sidelink transmission based on a prescribed probability, performing the sidelink transmission using the selected resource, and performing the subsequent sidelink transmission based on whether to reselect the resource, wherein the performing the sidelink transmission comprises transmitting information indicating whether to reselect the resource in the subsequent sidelink transmission.

In another technical aspect of the present invention, provided herein is a user equipment in a wireless communication system, the user equipment including a wireless communication module and a processor connected to the wireless communication module, wherein the processor is configured to select the resource for the sidelink transmission from a preset resource pool, determine whether to reselect the resource in a subsequent sidelink transmission based on a prescribed probability, perform the sidelink transmission using the selected resource, and perform the subsequent sidelink transmission based on whether to reselect the resource and wherein in performing the sidelink transmission, the processor transmits information indicating whether to reselect the resource in the subsequent sidelink transmission.

Preferably, if it is determined to reselect the resource in the subsequent sidelink transmission, the performing the subsequent sidelink transmission may include reselecting the resource for the sidelink transmission and performing the subsequent sidelink transmission using the reselected resource. On the contrary, if it is determined not to reselect the resource in the subsequent sidelink transmission, the performing the subsequent sidelink transmission may include performing the subsequent sidelink transmission using the selected resource.

More preferably, the performing the subsequent sidelink transmission may include if a configuration of the resource pool is changed, reselecting the resource for the sidelink transmission and performing the subsequent sidelink transmission using the reselected resource.

Additionally, the information indicating whether to reselect the resource in the subsequent sidelink transmission may be transmitted through a control signal for the sidelink transmission before performing the subsequent sidelink transmission.

### Advantageous Effects

According to an embodiment of the present invention, a resource can be efficiently allocated for D2D direct communication.

It will be appreciated by persons skilled in the art that that the effects that can be achieved through the present invention are not limited to what has been particularly described hereinabove and other advantages of the present invention will be more clearly understood from the following detailed description.

### DESCRIPTION OF DRAWINGS

FIG. 1 is a diagram schematically illustrating a network structure of an E-UMTS as an exemplary radio communication system.

FIG. 2 is a diagram illustrating structures of a control plane and a user plane of a radio interface protocol between a UE and an E-UTRAN based on the 3GPP radio access network specification.

FIG. 3 is a diagram illustrating physical channels used in a 3GPP system and a general signal transmission method using the same.

FIG. 4 is a diagram illustrating the structure of a radio frame used in an LTE system.

FIG. 5 is a diagram illustrating the structure of a DL radio frame used in an LTE system.

FIG. 6 is a diagram illustrating the structure of a UL subframe in an LTE system.

FIG. 7 is a diagram illustrating the concept of device-to-device (D2D) communication.

FIG. 8 illustrates an exemplary configuration of a resource pool and a resource unit.

FIG. 9 is a diagram exemplarily showing an operation that a UE sends a sidelink message having future resource information contained therein.

FIG. 10 shows an example of performing a resource reselection for sidelink according to the present invention.

FIG. 11 is a diagram showing configurations of a base station and UE applicable to an embodiment of the present invention.

### BEST MODE FOR INVENTION

The configuration, operation and other features of the present invention will be understood by the embodiments of the present invention described with reference to the accompanying drawings. The following embodiments are examples of applying the technical features of the present invention to a 3rd Generation Partnership Project (3GPP) system.

Although the embodiments of the present invention will be described based on an LTE system and an LTE-advanced (LTE-A) system, the LTE system and the LTE-A system are purely exemplary and the embodiments of the present invention can be applied to any communication system corresponding to the aforementioned definition. Moreover, although the present specification describes an embodiment of the present invention with reference to FDD system, this is just exemplary. And, the embodiments of the present invention can be applied to H-FDD or TDD system by being easily modified.

In the present disclosure, a base station (eNB) may be used as a broad meaning including a remote radio head (RRH), an eNB, a transmission point (TP), a reception point (RP), a relay, etc.

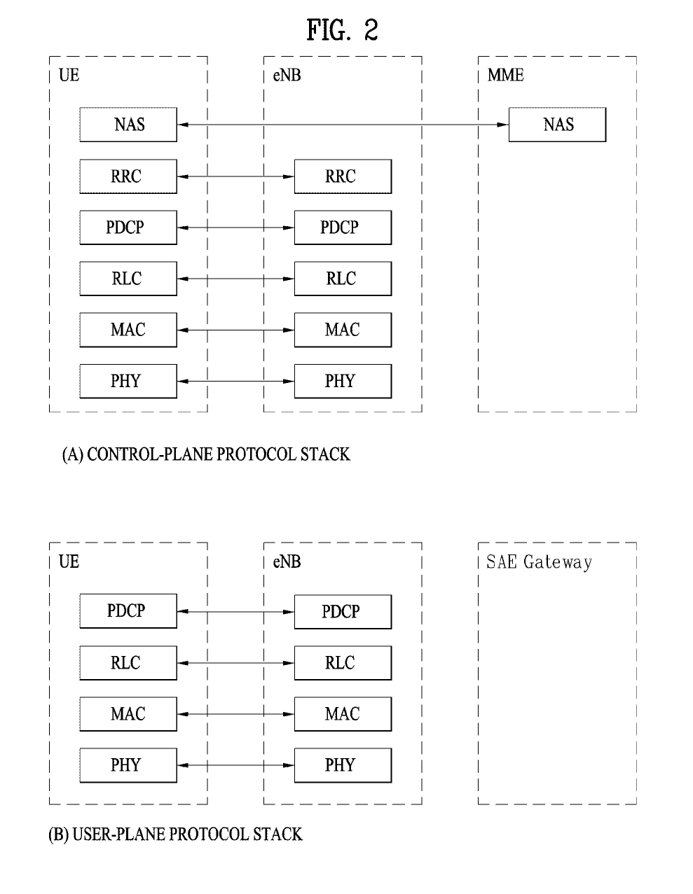

FIG. 2 is a diagram illustrating structures of a control plane and a user plane of a radio interface protocol between a UE and an E-UTRAN based on 3GPP radio access network specifications. The control plane refers to a path used for transmission of control messages, which is used by the UE and the network to manage a call. The user plane refers to a path in which data generated in an application layer, e.g. voice data or Internet packet data, is transmitted.

A physical layer of a first layer provides an information transfer service to an upper layer using a physical channel. The physical layer is connected to a media access control (MAC) layer of an upper layer via a transmission channel. Data is transmitted between the MAC layer and the physical layer via the transmission channel. Data is also transmitted between a physical layer of a transmitter and a physical layer of a receiver via a physical channel. The physical channel uses time and frequency as radio resources. Specifically, the physical channel is modulated using an orthogonal frequency division multiple Access (OFDMA) scheme in DL and is modulated using a single-carrier frequency division multiple access (SC-FDMA) scheme in UL.

The MAC layer of a second layer provides a service to a radio link control (RLC) layer of an upper layer via a logical channel. The RLC layer of the second layer supports reliable data transmission. The function of the RLC layer may be implemented by a functional block within the MAC layer. A packet data convergence protocol (PDCP) layer of the second layer performs a header compression function to reduce unnecessary control information for efficient transmission of an Internet protocol (IP) packet such as an IPv4 or IPv6 packet in a radio interface having a relatively narrow bandwidth.

A radio resource control (RRC) layer located at the bottommost portion of a third layer is defined only in the control plane. The RRC layer controls logical channels, transmission channels, and physical channels in relation to configuration, re-configuration, and release of radio bearers. A radio bearer refers to a service provided by the second layer to transmit data between the UE and the network. To this end, the RRC layer of the UE and the RRC layer of the network exchange RRC messages. The UE is in an RRC connected mode if an RRC connection has been established between the RRC layer of the radio network and the RRC layer of the UE. Otherwise, the UE is in an RRC idle mode. A non-access stratum (NAS) layer located at an upper level of the RRC layer performs functions such as session management and mobility management.

A cell constructing an eNB is configured by one of bandwidths among 1.25, 2.5, 5, 10, 15, and 20 MHz and provides DL or UL transmission service to a plurality of UEs. Cells different from each other can be configured to provide a different bandwidth.

DL transmission channels for data transmission from the network to the UE include a broadcast channel (BCH) for transmitting system information, a paging channel (PCH) for transmitting paging messages, and a DL shared channel (SCH) for transmitting user traffic or control messages. Traffic or control messages of a DL multicast or broadcast service may be transmitted through the DL SCH or may be transmitted through an additional DL multicast channel (MCH). Meanwhile, UL transmission channels for data transmission from the UE to the network include a random access channel (RACH) for transmitting initial control messages and a UL SCH for transmitting user traffic or control messages. Logical channels, which are located at an upper level of the transmission channels and are mapped to the transmission channels, include a broadcast control channel (BCCH), a paging control channel (PCCH), a common control channel (CCCH), a multicast control channel (MCCH), and a multicast traffic channel (MTCH).

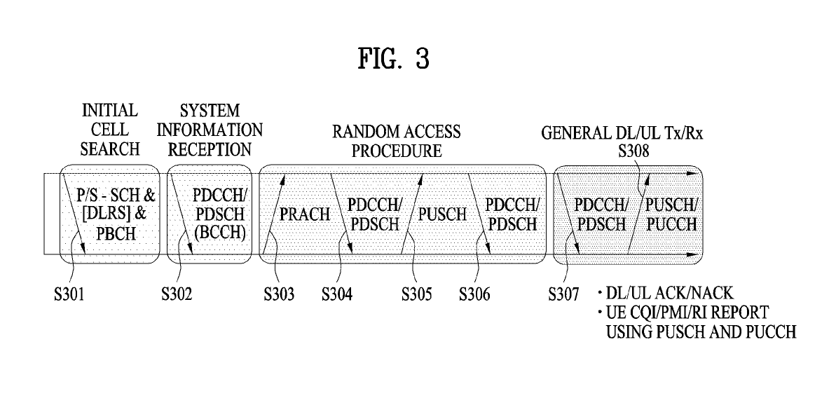

FIG. 3 is a diagram illustrating physical channels used in a 3GPP system and a general signal transmission method using the same.

When power is turned on or the UE enters a new cell, the UE performs an initial cell search procedure such as acquisition of synchronization with an eNB (S301). To this end, the UE may adjust synchronization with the eNB by receiving a primary synchronization channel (P-SCH) and a secondary synchronization channel (S-SCH) from the eNB and acquire information such as a cell identity (ID). Thereafter, the UE may acquire broadcast information within the cell by receiving a physical broadcast channel from the eNB. In the initial cell search procedure, the UE may monitor a DL channel state by receiving a downlink reference signal (DL RS).

Upon completion of the initial cell search procedure, the UE may acquire more detailed system information by receiving a physical downlink control channel (PDCCH) and receiving a physical downlink shared channel (PDSCH) based on information carried on the PDCCH (S302).

Meanwhile, if the UE initially accesses the eNB or if radio resources for signal transmission to the eNB are not present, the UE may perform a random access procedure (S303 to S306) with the eNB. To this end, the UE may transmit a specific sequence through a physical random access channel (PRACH) as a preamble (S303 and S305) and receive a response message to the preamble through the PDCCH and the PDSCH associated with the PDCCH (S304 and S306). In the case of a contention-based random access procedure, the UE may additionally perform a contention resolution procedure.

After performing the above procedures, the UE may receive a PDCCH/PDSCH (S307) and transmit a physical uplink shared channel (PUSCH)/physical uplink control channel (PUCCH) (S308), as a general UL/DL signal transmission procedure. Especially, the UE receives downlink control information (DCI) through the PDCCH. The DCI includes control information such as resource allocation information for the UE and has different formats according to use purpose thereof.

Meanwhile, control information that the UE transmits to the eNB on UL or receives from the eNB on DL includes a DL/UL acknowledgment/negative acknowledgment (ACK/NACK) signal, a channel quality indicator (CQI), a precoding matrix index (PMI), a rank indicator (RI), and the like. In the 3GPP LTE system, the UE may transmit the control information such as CQI/PMI/RI through a PUSCH and/or a PUCCH.

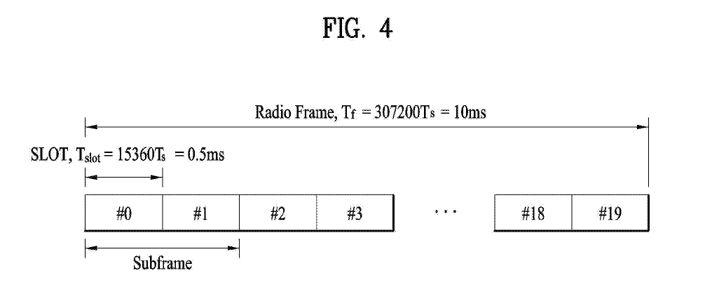

FIG. 4 is a diagram illustrating the structure of a radio frame used in an LTE system.

Referring to FIG. 4, the radio frame has a length of 10 ms (327200×Ts) and includes 10 equal-sized subframes. Each of the subframes has a length of 1 ms and includes two slots. Each slot has a length of 0.5 ms (15360 Ts). In this case, Ts denotes a sampling time represented by Ts=1/(15 kHz×2048)=3.2552×10⁻⁸ (about 33 ns). Each slot includes a plurality of OFDM symbols in the time domain and includes a plurality of resource blocks (RBs) in the frequency domain. In the LTE system, one RB includes 12 subcarriers×7 (or 6) OFDM symbols. A transmission time interval (TTI), which is a unit time for data transmission, may be determined in units of one or more subframes. The above-described structure of the radio frame is purely exemplary and various modifications may be made in the number of subframes included in a radio frame, the number of slots included in a subframe, or the number of OFDM symbols included in a slot.

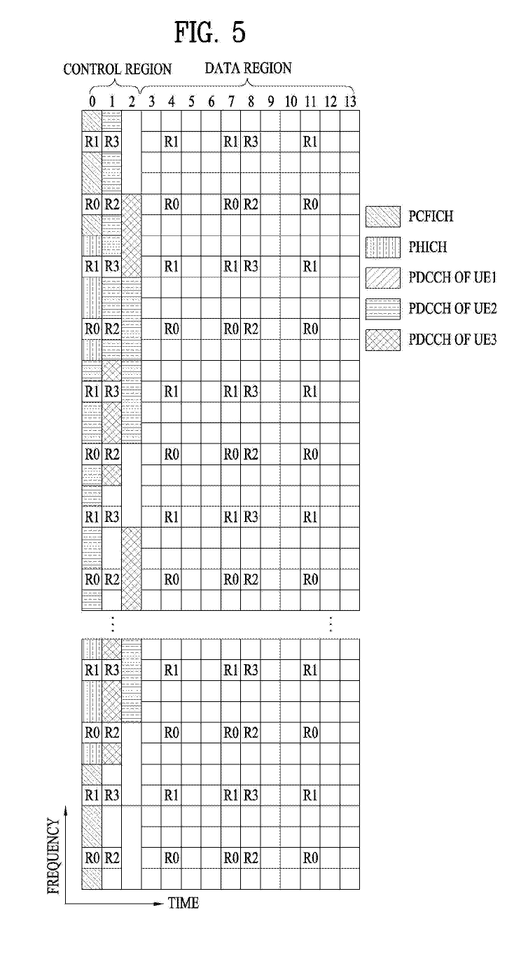

FIG. 5 is a diagram illustrating control channels included in a control region of one subframe in a DL radio frame.

Referring to FIG. 5, one subframe includes 14 OFDM symbols. The first to third ones of the 14 OFDM symbols may be used as a control region and the remaining 11 to 13 OFDM symbols may be used as a data region, according to subframe configuration. In FIG. 5, R0 to R3 represent reference signals (RSs) or pilot signals for antennas 0 to 3, respectively. The RSs are fixed to a predetermined pattern within the subframe irrespective of the control region and the data region. Control channels are allocated to resources unused for RSs in the control region. Traffic channels are allocated to resources unused for RSs in the data region. The control channels allocated to the control region include a physical control format indicator channel (PCFICH), a physical hybrid-ARQ indicator channel (PHICH), a physical downlink control channel (PDCCH), etc.

The PCFICH, physical control format indicator channel, informs a UE of the number of OFDM symbols used for the PDCCH in every subframe. The PCFICH is located in the first OFDM symbol and is configured with priority over the PHICH and the PDCCH. The PCFICH is composed of 4 resource element groups (REGs) and each of the REGs is distributed over the control region based on a cell ID. One REG includes 4 resource elements (REs). An RE indicates a minimum physical resource defined as one subcarrier by one OFDM symbol. The PCFICH value indicates values of 1 to 3 or values of 2 to 4 depending on bandwidth and is modulated using quadrature phase shift keying (QPSK).

The PHICH, physical hybrid-ARQ indicator channel, is used to carry a HARQ ACK/NACK signal for UL transmission. That is, the PHICH indicates a channel through which DL ACK/NACK information for UL HARQ is transmitted. The PHICH includes one REG and is cell-specifically scrambled. The ACK/NACK signal is indicated by 1 bit and is modulated using binary phase shift keying (BPSK). The modulated ACK/NACK signal is spread with a spreading factor (SF) of 2 or 4. A plurality of PHICHs mapped to the same resource constitutes a PHICH group. The number of PHICHs multiplexed to the PHICH group is determined depending on the number of spreading codes. The PHICH (group) is repeated three times to obtain diversity gain in the frequency domain and/or the time domain.

The PDCCH is allocated to the first n OFDM symbols of a subframe. In this case, n is an integer equal to or greater than 1, indicated by the PCFICH. The PDCCH is composed of one or more control channel elements (CCEs). The PDCCH informs each UE or UE group of information associated with resource allocation of transmission channels, that is, a paging channel (PCH) and a downlink shared channel (DL-SCH), UL scheduling grant, HARQ information, etc. The PCH and the DL-SCH are transmitted through a PDSCH. Therefore, the eNB and the UE transmit and receive data through the PDSCH except for particular control information or service data.

Information indicating to which UE or UEs PDSCH data is to be transmitted and information indicating how UEs should receive and decode the PDSCH data are transmitted on the PDCCH. For example, assuming that a cyclic redundancy check (CRC) of a specific PDCCH is masked by a radio network temporary identity (RNTI) ‘A’ and information about data transmitted using a radio resource ‘B’ (e.g. frequency location) and using DCI format ‘C’, i.e. transport format information (e.g. a transport block size, a modulation scheme, coding information, etc.), is transmitted in a specific subframe, a UE located in a cell monitors the PDCCH, i.e. blind-decodes the PDCCH, using RNTI information thereof in a search space. If one or more UEs having RNTI ‘A’ are present, the UEs receive the PDCCH and receive a PDSCH indicated by ‘B’ and ‘C’ based on the received information of the PDCCH.

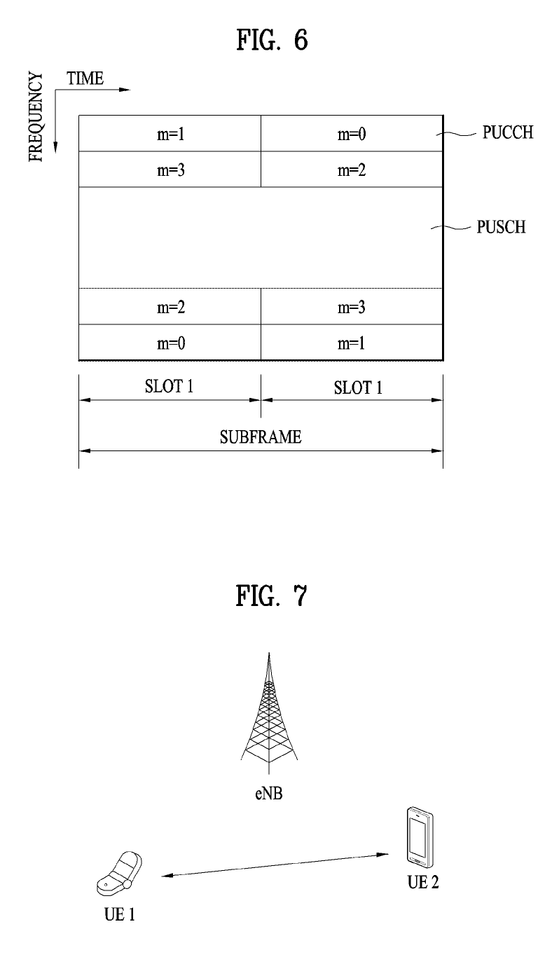

FIG. 6 is a diagram illustrating the structure of a UL subframe in an LTE system.

Referring to FIG. 6, an uplink subframe is divided into a region to which a PUCCH is allocated to transmit control information and a region to which a PUSCH is allocated to transmit user data. The PUSCH is allocated to the middle of the subframe, whereas the PUCCH is allocated to both ends of a data region in the frequency domain. The control information transmitted on the PUCCH includes an ACK/NACK, a channel quality indicator (CQI) representing a downlink channel state, an RI for Multiple Input and Multiple Output (MIMO), a scheduling request (SR) indicating a request for allocation of UL resources, etc. A PUCCH of a UE uses one RB occupying different frequencies in each slot of a subframe. That is, two RBs allocated to the PUCCH frequency-hop over the slot boundary. Particularly, PUCCHs for m=0, m=1, m=2, and m=3 are allocated to a subframe in FIG. 6.

FIG. 7 is a diagram illustrating the concept of device-to-device (D2D) communication.

Referring to FIG. 7, during D2D communication (i.e., D2D direct communication) in which the UE wirelessly communicates with another UE, the eNB may transmit a scheduling message for indicating D2D transmission/reception. The UE participating in D2D communication may receive a D2D scheduling message from the eNB, and performs Tx/Rx operations indicated by the D2D scheduling message. Here, although a UE means a user terminal, a network entity such as an eNB may be regarded as a UE when transmitting and receiving a signal according to a communication method between UEs. Moreover, it is possible for an eNB to receive a D2D signal transmitted by a UE. And, the UE can transmit an uplink signal, which includes a UE's signal transmitting/receiving method designed for D2D transmission, to the eNB.

Hereinafter, a link directly connected between UEs shall be referred to as a D2D link, and a link for a UE to communicate with an eNB shall be referred to as a NU link. Or, a link directly connected between UEs may be referred to as a SideLink (SL) as a concept compared to uplink and downlink.

Described in the following is a case that a UE 1 selects a resource unit corresponding to a specific resource from a resource pool that means a set of a series of resources and then transmits a sidelink signal using the corresponding resource unit. Here, if the UE 1 is located in a coverage of a base station, the base station may inform the UE 1 of the resource pool. If the UE 1 is out of the coverage of the base station, the resource pool may be indicated by another UE or determined as a resource determined in advance. Generally, a resource pool is configured with a plurality of resource units and each UE may select and use one or a plurality of resource units for a sidelink signal transmission of its own.

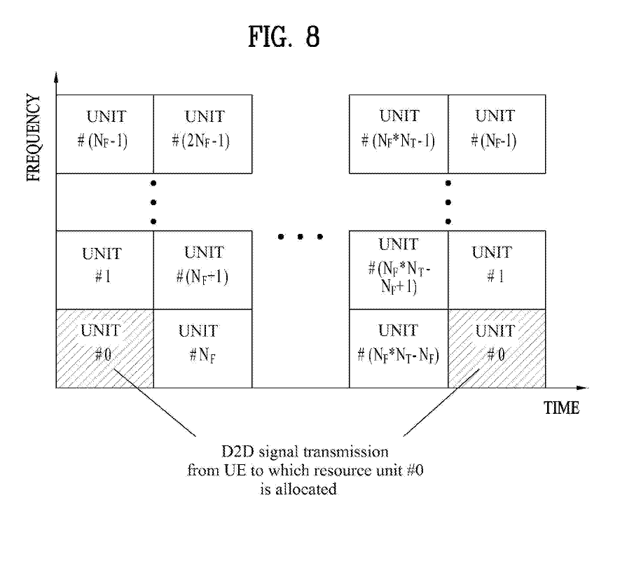

FIG. 8 shows a configurational example of a resource pool and a resource unit.

Referring to FIG. 8, an entire frequency resource is divided into NF and an entire time resource is divided into NT, whereby total NF*NT resource units are defined for example. Particularly, a corresponding resource pool may be repeated by period of NT subframes. Typically, a single resource unit may appear periodically and repeatedly. Or, in order to obtain a diversity effect in a time or frequency dimension, an index of a physical resource unit having a single logical resource unit mapped thereto may change in a previously determined pattern according to time. In such a resource unit structure, a resource pool may mean a set of resource units that can be used for a transmission by a UE intending to transmit a sidelink signal.

The above-described resource pool may be subdivided into various types. First of all, it can be classified according to a content of a sidelink signal transmitted on a resource pool. For example, like 1) to 3) in the following, a content of a sidelink signal may be classified into a sidelink data channel and a discovery signal. And, a separate resource pool may be configured according to each content.

1) Scheduling Assignment (SA): This refers to a signal including resource location information of a sidelink data channel followed by a transmitting (tx) UE and information such as Modulation and Coding Scheme (MCS) for demodulation of a data channel, an MIMO transmission scheme and the like. The SA can be transmitted in a manner of being multiplexed with sidelink data on the same resource unit. In this case, an SA resource pool may mean a pool of resources on which SA is transmitted by being multiplexed with sidelink data.

2) Sidelink data channel: This refers to a channel used for a tx UE to transmit user data. if SA is transmitted by being multiplexed with sidelink data on a same resource unit, a Resource Element (RE) used in transmitting SA information on a specific resource unit of an SA resource pool may be used to transmit sidelink data on a sidelink data channel resource pool.

3) Discovery signal: This means a resource pool for a signal enabling a neighboring UE to discover a tx UE in a manner that the tx UE transmits information such as its own ID and the like.

4) Synchronization signal/channel: This may be referred to as a sidelink synchronization signal or a sidelink broadcast channel, and mean a resource pool for a signal/channel for a receiving (rx) UE to achieve a goal of matching time/frequency synchronization with a tx UE in a manner that the tx UE transmits a synchronization signal and information relevant to synchronization.

Although SA and sidelink data can use a resource pool separated on a subframe, if a UE is able to transmit SA and sidelink data in a single subframe simultaneously, two kinds of resource pools may be configured in the same subframe.

### First Embodiment

Meanwhile, if a message arriving at a UE, which transmits a sidelink signal has a periodic attribute, it is advantageous for a tx UE in sidelink to select a resource once and use the resource consistently for a predetermined time. The reason for this is described as follows. First of all, if other neighboring UEs obtain a location of the selected resource of the corresponding tx UE once, they determine that the corresponding resource will be consistently used for a predetermined time and operate to use other resources so as to avoid collision.

Yet, in order to prevent consistent collision due to error generated from such a process and enable transmission/reception between UEs at different frequencies at the same timing as well, a UE consistently uses the selected-once resource for a predetermined time and preferably performs resource selection again by a predetermined rule. This operation may be referred to as reselection of a sidelink resource.

If different UEs perform sidelink resource reselection at the same timing, mutual detection is impossible as well. Hence, it is unable to obtain a desired result. As a method for solution, it is able to consider an operation that each UE probabilistically determines whether to perform sidelink resource reselection. Namely, with a predetermined probability, each UE determines whether to use a previous resource or a new resource for a resource for sending a specific message, before sending each message.

In some implementations, if a UE informs another UE of whether to use a resource currently used for a transmission of a specific message in the future, it is able to raise resource utilization. The reason for this is described as follows. First of all, if other UEs recognize that the corresponding UE will not use the corresponding resource at a next timing despite using the corresponding resource currently, they can consider using the corresponding resource. To this end, information on whether to continue to use a resource, information indicating until when the resource will continue being used when if using the resource and the like can be included in control information on a message transmission by the UE.

If combining the aforementioned two principles together, it may cause difficulty to an operation of a UE. A UE should determine how to use a resource at a future timing in advance and then transmit it to other UEs. If whether to reuse a resource is determined probabilistically at a message transmission timing, a presence or non-presence of reuse may not be determined at a transmission timing of control information. A probability for determining a presence or non-presence of reselection at each timing may be determined in advance.

Therefore, according to the present invention, a UE probabilistically determines a presence or non-presence of a future sidelink resource reselection in advance, informs other UEs of it through control information, and then determines whether to reuse or reselect a resource depending on the previously determined presence or non-presence of the reselection at a transmission timing of a corresponding message.

For example, assuming that a period for a UE to use a resource is P, a presence or non-presence of reselection of a resource for X periods in the future is determined at a timing x and a corresponding information is delivered as control information. For example, a presence or non-presence of reselection of a resource for 5 periods is determined. And, assume that probabilistic selections are made in a manner of an existing resource at a timing x, an existing resource at a timing x+P, an existing resource at a timing x+2P, a reselection at a timing x+3P, and an existing resource at a timing x+4P, respectively. While transmitting control information to another UE based on such information, a UE operates in a manner of making a reselection of a resource transmitted at the timing x+3P and maintaining the resource, which was selected at the timing x+3P, at the timing x+4P. Thus, since a presence or non-presence of reselection of a resource is already determined at each transmission timing, the UE can inform another UE of information indicating whether to maintain the resource.

Particularly, a UE can predetermine a presence or non-presence of reselection at each timing from a pseudo random sequence generated from information such as UE ID of its own and the like. For example, if a probability of a presence or non-presence of reselection is y, a UE generates a pseudo random sequence consisting of 0 and 1 and then binds it in unit of M bits. Moreover, the UE regards each unit as a numeral expressed as a binary number. If a numeral of a t^{th} unit is smaller than 2^{M}*y, the UE reselects a resource at a t^{th} timing. Otherwise, the UE can operate as maintaining an existing resource.

More particularly, when M=5, if a pseudo random sequence consisting of 10 bits is generated as [01101 11010], a numeral of a first unit and a numeral of a second unit become 13 and 26, respectively. Here, if y=0.5, since 2^{M}*y=16, a resource is reselected at a first timing but is not reselected at a second timing.

After a UE has determined a presence or non-presence of reselection up to a predetermined timing once, if one message transmission timing passes, the UE can operate as determining a presence or non-presence of a single reselection in the future only instead of determining a presence or non-presence of reselection at every timing again. For example, in a state that a UE determined a presence or non-presence of reselection of each of timings x, x+P, x+2P, x+3P and x+4P at the timing x, if the timing x passes, the UE determines a presence or non-presence of reselection at the timing x+5P only. If so, the UE is still in a situation of having determined a presence or non-presence of reselections of the timings x+P, x+2P, x+3P, x+4P and x+5P corresponding to 5 periods in the future at the corresponding timing. Since information transmitted to another UE at the timing x is still valid until the timing x+4P, a problem is not caused to an operation of another UE having received the information.

### Second Embodiment

Meanwhile, sidelink resource allocation for determining whether to use a prescribed resource in a resource pool may be classified into centralized resource allocation for a specific main agent as an eNB to determine a sidelink transmission resource of each UE and distributed resource allocation for a UE to determine a sidelink resource to use by itself. Particularly, if a prescribed UE performs distributed resource allocation, as several UEs use the same sidelink resource, resource collision causing interference to each other may possibly occur. Hence, an appropriate solution for this is required.

Meanwhile, a UE sends a sidelink message or an uplink message at a specific timing. In doing so, information on a time and/or frequency location of a resource to be used later, i.e., information on future resources may be included in such a message.

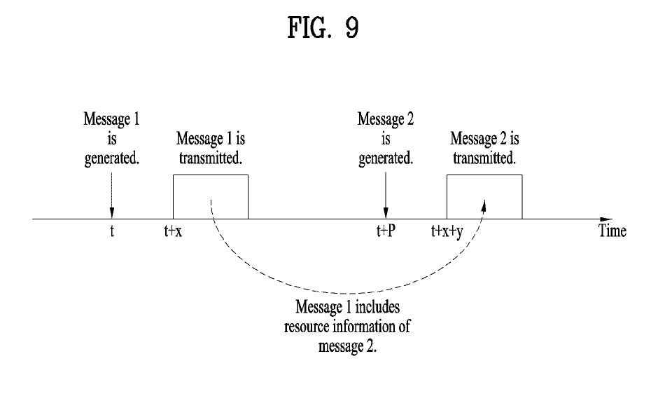

FIG. 9 is a diagram exemplarily showing an operation that a UE transmits future resource information in a manner that the future resource information is included in a sidelink message.

Referring to FIG. 9, when a UE sends a sidelink message generated by a predetermined period P, a message 1 created at a timing t starts to be transmitted at a timing t+x in a manner that the corresponding transmission contains a fact that a message 2, which will be created in a next period, will be transmitted using a specific frequency resource at a timing t+P+y. Thus, the UE can inform another UE of information on a future resource. Here, a time x or a time y indicates a delay time until a real transmission from a message creation. Generally, a message creation period P may have a value equal to or greater than 100 ms. Such future resource information may be transmitted through a separate control channel such as SA or transmitted in a manner of being included in a sidelink data channel, e.g., a partial field of a MAC header.

As described above, if a UE delivers future resource information, another UE having received the information can be aware where the corresponding UE will perform transmission in advance, whereby resource collision in a next transmission can be prevented as well. Yet, in some cases, a UE needs to reselect a resource consistently used by being selected once by the UE. Although a resource was selected appropriately in the past, as time passes, it may turn into an inappropriate resource under circumstances. A condition for triggering sidelink resource reselection should be determined appropriately by considering a gain (e.g., another UE's collision evasion) obtained from continuing an existing resource use and a corresponding loss (e.g., a situation of insufficient resources).

As one of conditions for triggering sidelink resource reselection, it is able to consider a case that a network including a base station reconfigures a resource pool. If a resource pool is reconfigured, a UE may be provided to stop a use of a previously used resource and attempt a sidelink resource reselection. As a resource pool is reconfigured, since various sidelink signal transmission attributes are changed, although a UE sticks to an existing resource selection, if an existing resource is not suitable for resource pool reconfiguration, it may cause a problem of fairness with another UE.

If an SA resource pool is reconfigured to get smaller, a UE maintaining an existing SA resource eventually uses an SA resource that cannot be used by other UEs. Moreover, since a UE attempting a reception based on resource pool reconfiguration is unable to perform correct reception, this may become a problem as well. Hence, in case that a resource pool is reconfigured, a UE operates in a manner of performing sidelink resource reselection within a predetermined time from a timing of receiving resource pool reconfiguration and then attempting a transmission with a new resource.

Here, reconfiguration of a resource pool may be more than reconfiguring a time/frequency resource of a specific channel simply. Although resource information for SA or data is identical, if various parameters applied in using a corresponding resource pool are reconfigured, a UE may operate to perform sidelink resource reselection. Examples of such transmission parameters may include the following. And, various parameters may be delivered as subsidiary information of resource pool reconfiguration to a UE by a network.
Parameter for adjusting sidelink transmit power

A parameter used for an equation for determining sidelink transmit power of a UE on the basis of pathloss with an eNB may be included. A network can adjust a transmit power parameter according to a load situation of a sidelink. The network can reconfigure the parameter to use low power in order to reduce interference when the load gets heavier.
Parameter for adjusting an amount of a sidelink transmission resource

This is a parameter for adjusting an amount of a time and frequency resource used for an individual sidelink message transmission by a UE. This parameter may be configured in a manner of indicating an amount of a maximum and/or minimum time and frequency resource usable for the individual sidelink message transmission. A network can adjust a resource amount parameter depending on a load situation of a sidelink. The network can reconfigure the parameter to use a less amount of resource in order to reduce interference when the load gets heavier.
Parameter for adjusting time relationship between SA and data

If SA is transmitted in a specific subframe and data scheduled by the SA is transmitted in a subsequent subframe, a parameter for providing time relationship between the SA and the data can be configured by a network.

Typically, although a resource pool or various parameters are reconfigured, if the resource pool or the various parameters are related to a sidelink reception operation (e.g., if the resource pool or the various parameters correspond, as resource pools or parameters transmitted by neighboring cell UEs, to configuration of a reception operation for a corresponding UE), since the resource pool or the various parameters are irrelevant to a sidelink transmission operation of its own, the UE may operate to reuse an existing resource without triggering sidelink resource reselection.

The resource pool and the transmission relevant parameter can be delivered to an individual UE through UE-specific signaling. Particularly, this may be an operation corresponding to an RRC Connected mode UE. In this case, a network can utilize it for the usage of triggering sidelink resource reselection of a specific UE. For example, if a network directly monitors a sidelink situation and determines that resource selection of a specific UE is inappropriate (e.g., determining that a resource colliding with another neighboring UE is selected), the network can trigger sidelink resource reselection by sending a resource pool reconfiguration message to the corresponding UE. Particularly, although a resource pool or a transmission relevant parameter before sidelink resource reselection is equal to that after sidelink resource reselection, if the resource pool reconfiguration message is received, the corresponding UE may operate to perform reselection. If so, sidelink resource reselection may be triggered without changing the resource pool or the transmission relevant parameter substantially.

Of course, the resource pool and the transmission relevant parameter may be delivered to several UEs through UE-common signaling (e.g., SIB). Particularly, this may be an operation corresponding to an RRC_Idle mode UE. In this case, a network can utilize it for the usage of triggering sidelink resource reselection of all UEs. For example, if a network directly monitors a sidelink situation and determines that overall load is too high or low, the network can trigger sidelink resource reselection by sending a resource pool reconfiguration message to all UEs. Typically, although a resource pool or a transmission relevant parameter is equal to the previous one, if the resource pool reconfiguration message is received, the corresponding UE may operate to perform reselection, which can be used to trigger reselection without changing the corresponding configuration substantially.

As an exception of the above-described operation, if a previously selected resource is suitable for a reconfiguration resource, the corresponding resource may operate to be maintained exceptionally. For example, after a UE has selected a specific resource for data transmission, although a resource pool reconfiguration message is received, if the selected resource still belongs to a reconfigured resource pool and is suitable for configuration by a resource amount relevant parameter (e.g., within a configured minimum/maximum use resource amount of the selected resource), the UE may maintain an existing resource without triggering reselection.

For another example of a condition for triggering sidelink resource reselection, there is a case that a transmission parameter needs to be adapted. A UE may operate to adapt a transmission parameter (e.g., a parameter used for transmit power configuration, a time/frequency use amount of an individual packet, etc.) to various situations. Particularly, in case that a moving speed of a UE is fast, the UE may operate to use higher power to raise coverage or more resources for individual packet transmission so as to enable communication with a UE in a relatively long distance. The reason for this is to deliver necessary information before approaching the UE in the relatively long distance.

For another example, in case that a UE changes a reference of synchronization from the more stable like GNSS into the relatively less stable like a base station signal or a transmitted signal of the UE, it may operate to use higher power or more resources for individual packet transmission in order to prevent performance degradation caused by the increasing synchronization error.

Thus, as a situation of a UE changes, if a transmission parameter needs to be changed correspondingly, the UE may be provided to reselect a resource. Through this, the UE can perform transmission suitable for a new parameter quickly.

For another example, if a UE obtains a load situation of a channel and determines that a load becomes equal to or higher than a predetermined level, the UE can operate to change a transmission parameter so as to cope with it. If such an operation is triggered, the UE may be provided to reselect a resource.

In the above-described operation, if a UE uses a plurality of resources (e.g., resources across a plurality of subframes), a detailed form of performing sidelink resource reselection has the following possibility.

First of all, if sidelink resource reselection is triggered once, a UE can perform reselection on all resources selected previously. Such an operation may be suitable for a case of scheduling a plurality of data resources through an SA transmitted once. This is because a new SA should be transmitted anyway despite that sidelink resource reselection occurs in part. In some implementations, if the sidelink resource reselection is triggered once, the UE can perform reselection on some of the previously selected resources. A resource targeted for reselection may be determined probabilistically, or only a resource not suitable for new configuration may be selectively reselected using the aforementioned principles.

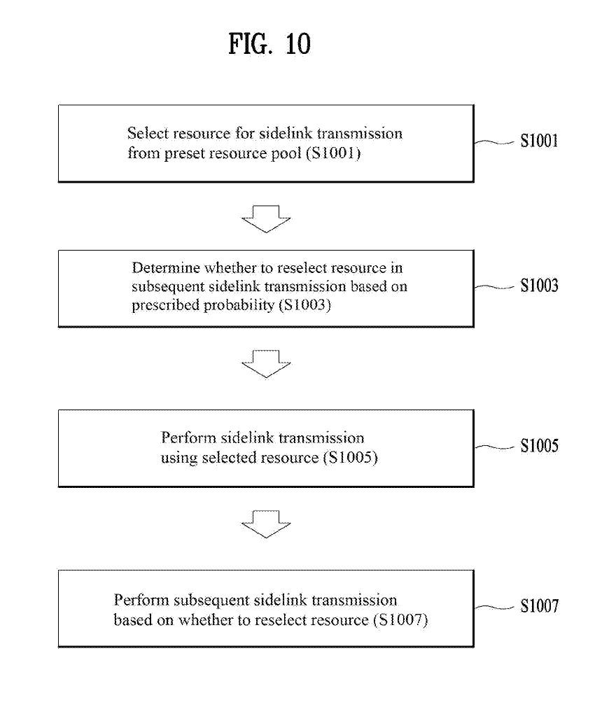

FIG. 10 shows an example of performing a resource reselection for sidelink according to the present invention.

Referring to FIG. 10, in a step 1001, a resource for sidelink transmission is selected from a preset resource pool. In a step 1003, whether to reselect the resource in a subsequent sidelink transmission is determined based on a prescribed probability.

In a step 1005, a UE performs the sidelink transmission using the selected resource. Here, when the sidelink transmission is performed, it is characterized in transmitting information indicating whether to reselect the resource is transmitted in the subsequent sidelink transmission. Particularly, the information indicating whether to reselect the resource is transmitted in the subsequent sidelink transmission is characterized in being transmitted through a control signal for the sidelink transmission before performing the subsequent sidelink transmission.

Finally, in a step 1007, the UE performs the subsequent sidelink transmission based on whether to reselect the resource. If it is determined to reselect the resource for the subsequent sidelink transmission in the step 1003, the resource for the sidelink transmission is reselected and the subsequent sidelink transmission is performed. On the contrary, if it is determined not to reselect the resource for the subsequent sidelink transmission in the step 1003, the subsequent sidelink transmission is performed by reusing the selected resource.

Additionally, if the configuration of the resource pool is changed, the resource for the sidelink transmission is reselected and the subsequent sidelink transmission is preferably performed using the reselected resource.

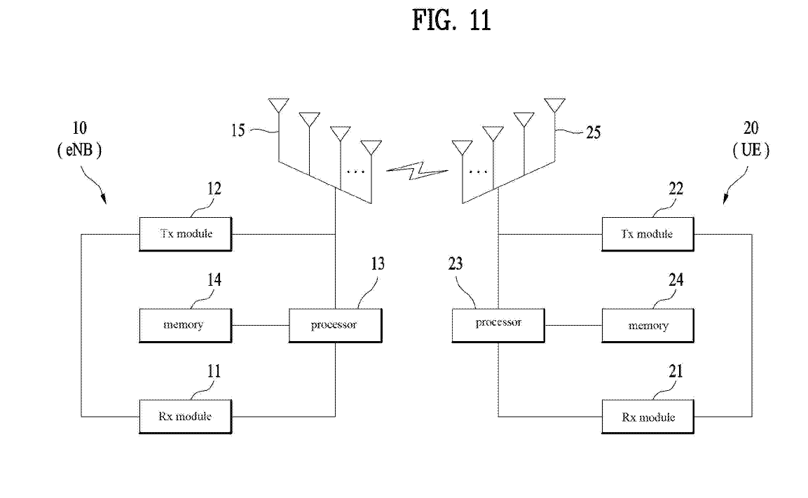

FIG. 11 is a diagram showing configurations of a base station and UE applicable to an embodiment of the present invention.

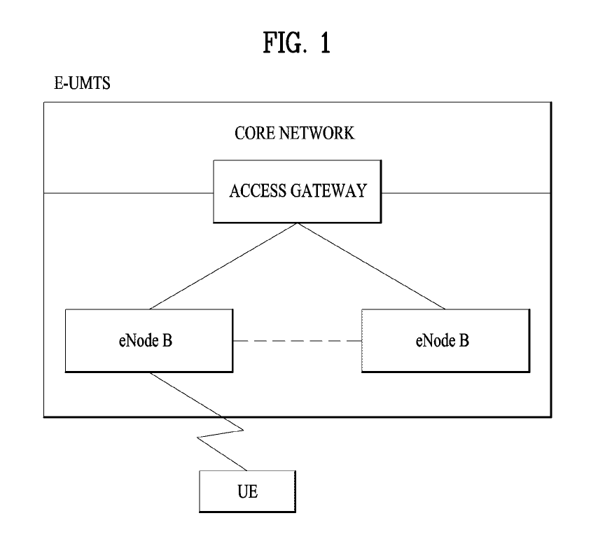

Referring to FIG. 11, an eNB 10 according to the present invention may include a receiving module 11, a transmitting module 12, a processor 13, a memory 14 and a plurality of antennas 15. A plurality of the antennas 15 may mean an eNB supportive of MIMO transmission and reception. The receiving module 11 can receive various signals, data and information in uplink from a user equipment. The transmitting module 12 can transmit various signals, data and information in downlink to the user equipment. And, the processor 13 can control overall operations of the eNB 10. Particularly, the processor 13 of the eNB 10 according to one embodiment of the present invention can process or handle the items required for the respective embodiments mentioned in the foregoing description with reference to FIGS. 1 to 10.

The processor 13 of the eNB 10 performs functions of operating and processing information received by the eNB 10, information to be transmitted by the eNB 10, and the like. The memory 14 can store the operated and processed information and the like for a prescribed period and be substituted with such a component as a buffer (not shown in the drawing) and the like.

Referring still to FIG. 11, a User Equipment (UE) 20 according to the present invention may include a receiving module 21, a transmitting module 22, a processor 23, a memory 24 and a plurality of antennas 25. A plurality of the antennas 25 may mean a user equipment supportive of MIMO transmission and reception. The receiving module 21 can receive various signals, data and information in downlink from a transmitting point. The transmitting module 22 can transmit various signals, data and information in uplink to the transmitting point. And, the processor 23 can control overall operations of the user equipment 20.

Particularly, the processor 23 of the user equipment 20 according to one embodiment of the present invention can process or handle the items required for the respective embodiments mentioned in the foregoing description with reference to FIGS. 1 to 10.

The processor 23 of the user equipment 20 performs functions of operating and processing information received by the user equipment 20, information to be transmitted by the user equipment 20, and the like. The memory 24 can store the operated and processed information and the like for a prescribed period and be substituted with such a component as a buffer (not shown in the drawing) and the like.

The above-mentioned embodiments correspond to combinations of elements and features of the present invention in prescribed forms. And, it is able to consider that the respective elements or features are selective unless they are explicitly mentioned. Each of the elements or features can be implemented in a form failing to be combined with other elements or features. Moreover, it is able to implement an embodiment of the present invention by combining elements and/or features together in part. A sequence of operations explained for each embodiment of the present invention can be modified. Some configurations or features of one embodiment can be included in another embodiment or can be substituted for corresponding configurations or features of another embodiment. And, it is apparently understandable that an embodiment is configured by combining claims failing to have relation of explicit citation in the appended claims together or can be included as new claims by amendment after filing an application.

In this disclosure, a specific operation explained as performed by a base station may be performed by an upper node of the base station in some cases. In particular, in a network constructed with a plurality of network nodes including a base station, it is apparent that various operations performed for communication with a terminal can be performed by a base station or other networks other than the base station. ‘Base station (BS)’ may be substituted with such a terminology as a fixed station, a Node B, an eNode B (eNB), an access point (AP) and the like.

Embodiments of the present invention can be implemented using various means. For instance, embodiments of the present invention can be implemented using hardware, firmware, software and/or any combinations thereof. In case of the implementation by hardware, a method according to each embodiment of the present invention can be implemented by at least one of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, a method according to each embodiment of the present invention can be implemented by modules, procedures, and/or functions for performing the above-explained functions or operations. Software code is stored in a memory unit and is then drivable by a processor. The memory unit is provided within or outside the processor to exchange data with the processor through the various means known to the public.

It will be apparent to those skilled in the art that various modifications and variations can be made therein without departing from the spirit and scope of the invention. Therefore, the detailed description should not be interpreted restrictively in all aspects but considered as exemplary. Thus, it is intended that the present invention covers the modifications and variations of this invention that come within the scope of the appended claims and their equivalents.

### INDUSTRIAL APPLICABILITY

Although the aforementioned method of configuring a resource for Device-to-Device (D2D) direct communication in a wireless communication system and apparatus therefor are described by focusing on examples applying to the 3GPP LTE system, they are applicable to various wireless communication systems as well as to the 3GPP LTE system.

What is claimed is:

1. A method of configuring a resource for sidelink transmission by a user equipment in a wireless communication system, the method comprising:
selecting the resource for the sidelink transmission from a preset resource pool;
determining whether to reselect the resource in a subsequent sidelink transmission based on a prescribed probability;
performing the sidelink transmission using the selected resource; and
performing the subsequent sidelink transmission based on whether to reselect the resource,
wherein the performing the sidelink transmission comprises transmitting information indicating whether to reselect the resource in the subsequent sidelink transmission.

2. The method of claim 1, wherein if it is determined to reselect the resource in the subsequent sidelink transmission, the performing the subsequent sidelink transmission comprises reselecting the resource for the sidelink transmission and performing the subsequent sidelink transmission using the reselected resource.

3. The method of claim 1, wherein if it is determined not to reselect the resource in the subsequent sidelink transmission, the performing the subsequent sidelink transmission comprises performing the subsequent sidelink transmission using the selected resource.

4. The method of claim 1, the performing the subsequent sidelink transmission, comprising:
if a configuration of the resource pool is changed, reselecting the resource for the sidelink transmission; and
performing the subsequent sidelink transmission using the reselected resource.

5. The method of claim 1, wherein the information indicating whether to reselect the resource in the subsequent sidelink transmission is transmitted through a control signal for the sidelink transmission before performing the subsequent sidelink transmission.

6. A user equipment in a wireless communication system, the user equipment comprising:
a wireless communication module; and
a processor connected to the wireless communication module,
wherein the processor is configured to select the resource for the sidelink transmission from a preset resource pool, determine whether to reselect the resource in a subsequent sidelink transmission based on a prescribed probability, perform the sidelink transmission using the selected resource, and perform the subsequent sidelink transmission based on whether to reselect the resource and
wherein in performing the sidelink transmission, the processor transmits information indicating whether to reselect the resource in the subsequent sidelink transmission.

7. The user equipment of claim 6, wherein if it is determined to reselect the resource in the subsequent sidelink transmission, the processor reselects the resource for the sidelink transmission and performs the subsequent sidelink transmission using the reselected resource.

8. The user equipment of claim 6, wherein if it is determined not to reselect the resource in the subsequent sidelink transmission, the processor performs the subsequent sidelink transmission using the selected resource.

9. The user equipment of claim 6, wherein if a configuration of the resource pool is changed, the processor reselects the resource for the sidelink transmission and performs the subsequent sidelink transmission using the reselected resource.

10. The user equipment of claim 6, wherein the information indicating whether to reselect the resource in the subsequent sidelink transmission is transmitted through a control signal for the sidelink transmission before performing the subsequent sidelink transmission.
